(19) United States
(12) Patent Application Publication
(10) Pub. No.: US 2022/0227188 A1
(43) Pub. Date: Jul. 21, 2022

(54) ANTI-SKID DEVICE WITH EXTERNAL MOUNTING TO THE HUB OF A WHEEL PARTICULARLY FOR WHEELS WITH ALLOY RIMS

(71) Applicant: KÖNIG S.P.A, Suello (Lecco) (IT)

(72) Inventor: Stefano NECCHI, Montevecchia (Lecco) (IT)

(21) Appl. No.: 17/614,761

(22) PCT Filed: May 6, 2020
(86) PCT No.: PCT/EP2020/062592

§ 371 Date: Nov. 29, 2021

(30) Foreign Application Priority Data
May 30, 2019 (IT) 102019000007662

(51) Int. Cl. B60C 27/06; B60C 27/10

(52) U.S. Cl. CPC B60C 27/065; B60C 27/10

(57) ABSTRACT

An anti-skid device with mounting from the outside for wheels, particularly with alloy rims with central hole, includes: a central body intended to be placed at the hub of a wheel on which the anti-skid device is to be mounted; arms radially protruding from this central body and terminating in terminal elements intended to be placed on the tread of the tire; chain segments connected to the terminal elements forming a ring on the tread of the tire; a device designed to be fixed to the rim of the wheel; a connecting element between the device and the central body of the anti-skid device; and a tensioning mechanism placed in the central body which can be actuated to pull the connecting element and bring the central body closer to the wheel hub. The device is an expansion device fixed in the central hole of the rim of the wheel.

### BACKGROUND OF THE INVENTION

### Field of the Invention

The present invention relates to an anti-skid device, commonly referred to as a snow chain, for wheels with alloy rims, designed to be mounted from the side of the wheel turned towards the outside of the vehicle.

### Description of the Related Art

Snow chains are known with external mounting that comprise a central hub from which a plurality of arms or spokes protrude radially, connected to a terminal element that embraces the tread of the tire. The terminal elements of the spokes are connected to chain segments that follow the tire tread. In this way, the chain segments can scratch or score the sleet or ice on the road surface to exert greater friction and prevent the tires from slipping and skidding.

For the attachment and tensioning of this type of snow chains, the most common solution is to provide an adapter element that is attached to a wheel bolt or nut. The adapter element is attached to the end of a tensioning belt or chain which traverses the hub of the anti-skid device, where means of various type are provided, such as lever, ratchet, or the like, which can be actuated by the user to tension the belt and bring the hub of the anti-skid device closer to the hub of the wheel.

Such a type of snow chain has various disadvantages due to the way in which the tensioning element is fixed to a bolt of the wheel.

In fact, users must normally use a special wrench to screw-fix the adapter device to the bolt. In some cases a lever is provided, fixed to the adapter, to enable the screwing thereof, a lever which remains on the wheel during travel, so that a force acting in the direction opposite to that of screwing on the adapter device would tend to loosen the clamping of the same.

In addition, the fixing of the tensioning element to a bolt of the wheel is somewhat difficult and not entirely reliable.

Moreover, since the bolts for fixing of the wheel are distanced from the centre of the same, and consequently the element of connection to the hub of the anti-skid device is offset with respect to the wheel, this may result in imperfect tensioning and/or mounting of the anti-skid device.

Snow chains of the type described above are known, for example, from WO 03/011618, EP 2050590 and EP 528506.

U.S. Pat. No. 2,517,634 and EP 35282874 describe other anti-skid devices with external mounting with features.

### SUMMARY OF THE INVENTION

The object of the present invention is to eliminate, or at least reduce, the disadvantages of the prior art illustrated above.

In particular, one object of the invention is to provide an anti-skid device for wheels with alloy rims, i.e. provided with a hole at the hub, closed by a small disk normally bearing the car manufacturer's logo, which is easy and quick to assemble and disassemble.

Another object of the invention is to provide such an anti-skid device wherein the tensioning element is perfectly in axis with the wheel, in such a way as to allow a symmetrical and uniform distribution of the tensioning forces and ensure safety and reliability during travel of the vehicle.

These and other objects are achieved by the anti-skid device as disclosed and claimed, as are various advantageous embodiments.

Substantially, the anti-skid device with mounting from the outside for wheels, particularly with alloy rims with a central hole, according to the invention, comprises:
a central body intended to be placed at the hub of a wheel on which the anti-skid device is to be mounted,
a plurality of arms projecting radially from said central body and terminating in terminal elements intended to be placed on the tire tread,
chain segments connected to said terminal elements so as to form a ring on the tire tread,
a device designed to be attached to said rim of the wheel;
a connecting element between said fixing device and said central body of the anti-skid device, and
a tensioning mechanism placed in said central body which can be operated to pull said connecting element and bring the central body closer to the hub of the wheel, wherein said fixing device is an expansion fixing device which is fixed in said central hole of the rim of the wheel.

### BRIEF DESCRIPTION OF THE DRAWINGS

Further features of the invention will be made clearer by the detailed description that follows, referred to its embodiments purely by way of a non-limiting example, illustrated in the accompanying drawings, in which:

FIG. 1 is a schematic view in perspective, illustrating the mounting of an anti-skid device fitted with a device for fixing to the rim of the wheel according to a first embodiment of the invention;

FIG. 2 is an enlargement showing in particular the connection between the anti-skid device and the fixing device mounted on the wheel before tensioning;

FIG. 3 shows schematically a wheel with the device for fixing of the anti-skid device according to the previous figures mounted thereon;

FIGS. 4 and 5 are schematic perspective views of the fixing device in rest and working condition respectively;

FIGS. 6 and 7 are axial schematic sections of the fixing device of FIGS. 4 and 5, respectively, placed in the hole of the hub of a wheel;

FIGS. 8 and 9 are perspective views of a second embodiment of the fixing device, in rest and working condition respectively;

FIGS. 10 and 11 are schematic sectioned views of the device of FIGS. 8 and 9, respectively, mounted on the wheel;

FIGS. 12 and 13 are schematic views in perspective of a fixing device according to a third embodiment of the invention, in rest and working condition respectively;

FIGS. 14 and 15 are views in median section of the device of FIGS. 12 and 13, respectively, mounted on a wheel.

### DESCRIPTION OF THE PREFERRED EMBODIMENTS

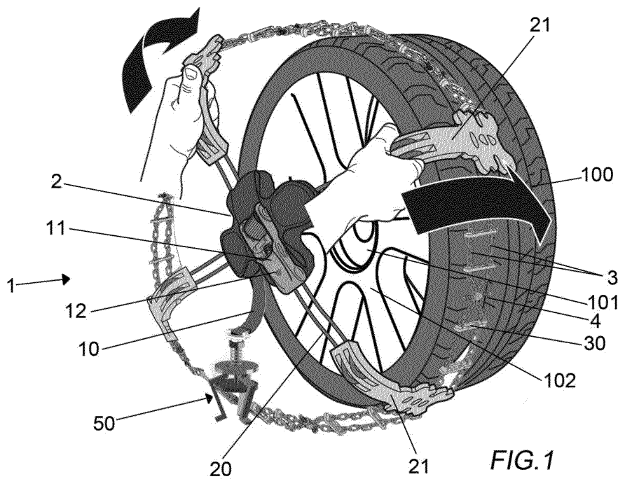

Referring to FIG. 1, an anti-skid device according to a first embodiment of the invention, denoted as a whole by reference numeral 1, is shown during the phase of mounting on a wheel 100.

The anti-skid device, or snow chain, 1, comprises a hub or central body 2 intended to be placed at the hub of the wheel. From the central body 2 of the anti-skid device arms or spokes 20 branch off radially. Four arms 20, each consisting of a pair of appropriately shaped metal rods, are shown in the drawings.

The ends of the arms 20 are connected to respective terminal elements 21 bent with a radius of curvature that follows the edge of the tire, in such a way that the terminal elements 21 can be placed on the tread of the tire of the wheel. Chain segments 3 are connected to the terminal elements 21 and are arranged in a ring along the tread of the tire. By way of example, the drawing shows two chain segments 3 arranged substantially parallel one to the other. At appropriate intervals, the chain segments 3 are connected one to the other and held in position by transverse plates 30 which are arranged in a knife pattern on the tread of the tire, in such a way as to improve friction with the road surface, cutting into the ice or snow.

Between at least some pairs of transverse plates 30 an adjustment device 4 is placed, in itself known, to adapt the chain segments 3 to slightly different wheel diameters or even to compensate the wear of the tire, which leads to a reduction in wheel diameter. For the mounting of the anti-skid device 1 to wheel 100 a device is provided for fixing to the central hole 101 of rim 102 of wheel 100.

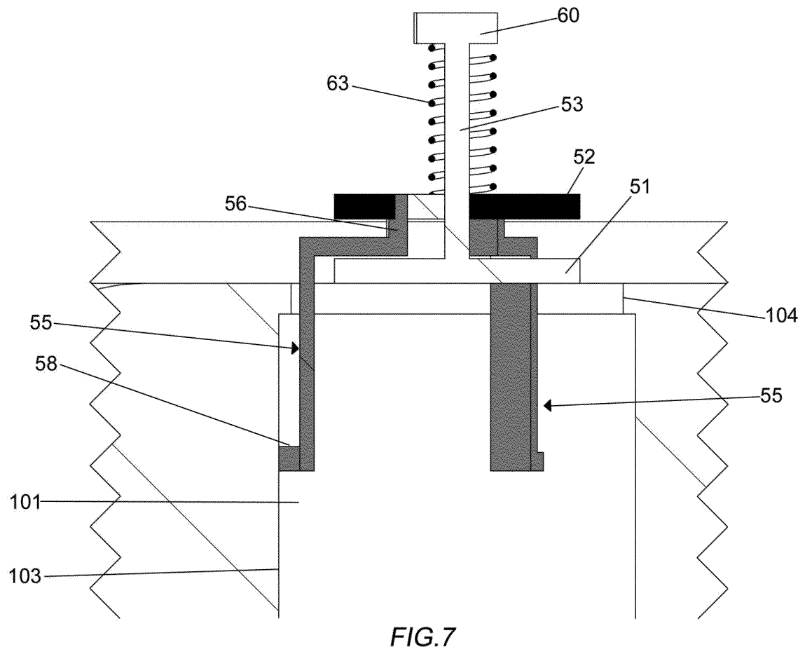

This device, which will be described in greater detail here below, is denoted by reference numeral 50 in FIGS. 1 to 7, and is connected by means of a belt 10 to a mechanism 11 placed in the central body 2, and through actuation thereof it is possible to tension the anti-skid device.

This mechanism 11 is in itself known and, only by way of example, in FIG. 1 it is shown as a ratchet lever, as described for example in European patent EP 2050591, to which reference can be made for further details of the same.

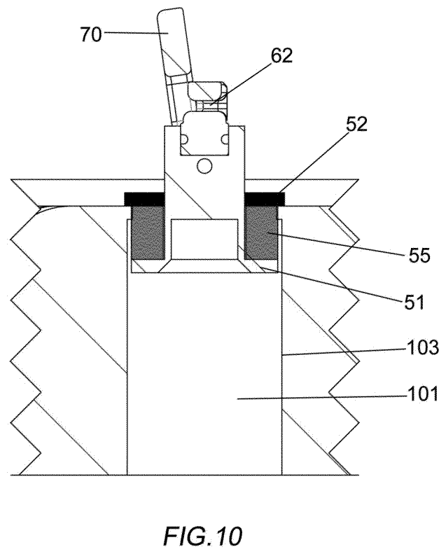

It should also be noted that the connection between the central body 2 of the anti-skid device and the fixing device 50 can be made, instead of with a belt as shown in FIG. 10, with a chain, a steel cable, or the like.

Likewise, this belt 10 can be permanently connected to the fixing device 50, or hooked thereto during mounting, in which case it will be removable.

Before describing in detail the device for fixing to the wheel, which is a specific subject of the invention, the mounting of the anti-skid device is described in brief.

Referring to FIG. 1, the user grasps two spokes 20 of the anti-skid device 1 to mount them on the outer part of wheel 100, placing the ring formed by the chain segments 3 on the tread of the tire.

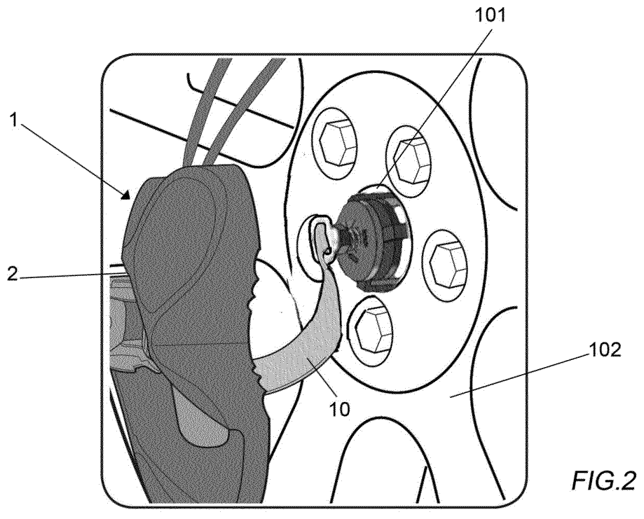

As shown in FIG. 2, the operator then grasps the fixing device 50 and locks it in the central hole 101 of the wheel.

Naturally, if device 50 is separated from belt 10 or other element of connection to the central body 2 of the anti-skid device, it will be placed in hole 101 beforehand, and then belt 10 will be hooked thereto.

At this point, the tensioning mechanism 11 is actuated by means of the ratchet lever 12, causing the belt 10 to be shortened, and therefore the central body 2 of the anti-skid device 1 to be brought closer to the hub of the wheel, tensioning in this way the terminal elements 21 of the arms 20 on the tire.

For dismounting, the procedure is in reverse order, releasing the ratchet tensioning mechanism, so as to cause the belt 10 to loosen, allowing the anti-skid device 1 to move away from the wheel and its removal, following the release of the belt 10 and/or the removal of the fixing device 50.

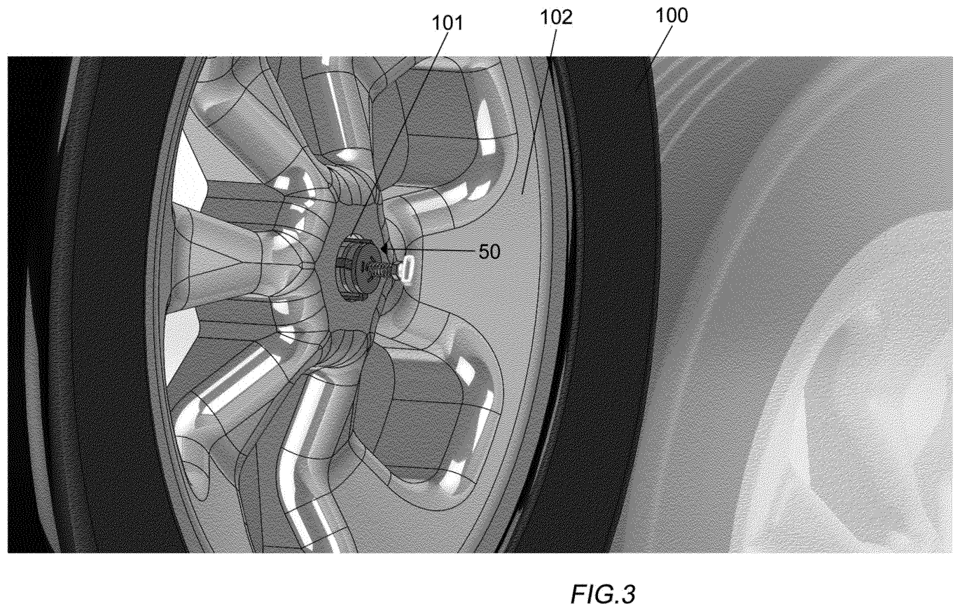

Referring to FIGS. 3 to 7, fixing device 50 is described according to a first embodiment of the invention.

In FIG. 3, fixing device 50 is shown mounted in the central hole 101 of an alloy rim 102 of a wheel 100.

In fact, alloy rims are provided with a blind hole 101 at the hub normally covered by a small disk usually bearing the logo of the car manufacturer of the vehicle, following the removal of which device 50 can be mounted in said hole 101.

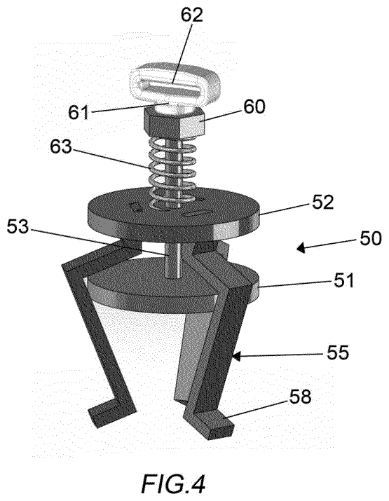

FIGS. 4 to 7 show in greater detail the structure of fixing device 50 and its mounting in hole 101.

Device 50 comprises a pair of disks 51, 52 parallel to and coaxial one with the other, the lower disk 51 (referring to the drawings) being made integral with the end of a rod 53, at least partially threaded, which traverses a threaded hole 54 provided centrally to the upper disk 52.

The end of the rod 53 can be connected in a fixed manner to the lower disk 51, so that these two elements behave as a monobloc, or connected in such a way that the disk 51 is free to rotate around the rod 53.

Between the two disks 51 and 52 L-shaped tabs 55 are placed (three in number in the example shown), with the ends bent at 90° outwards.

The upper bent ends 56 are housed in corresponding holes 57 formed in the upper disk 52, while the lower bent ends 58 are engaged with the inner wall 103 of the hole 101 during mounting.

At the other end of the rod 53, opposite that of engagement with disk 51, a polygonal head 60 is provided to allow the screwing/unscrewing of the rod 53. On the head 60 a small pin 61 is provided, which can be optionally pivotally mounted with respect to the head 60, carrying an eyelet 62 for the insertion of the belt 10.

Naturally the shape of the head 60 and of the small pin 61 with eyelet 62 is purely indicative, as these elements can take on other forms suitable for the purposes, i.e. the rotation of the rod 53 and the engagement of the connecting element 10 with the central body 2 of the anti-skid device.

A pressure spring 63 that acts between head 60 and upper disk 52 can also be provided on rod 53.

FIG. 4 shows device 50 in a non-operational condition, with tabs 55 in “loosened” condition.

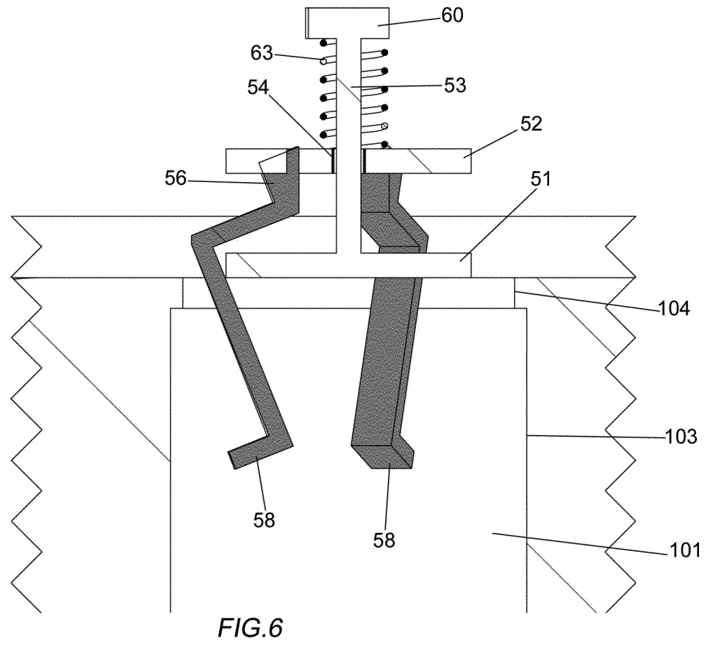

In this condition, device 50 is positioned against the hub of the wheel, inserting the tabs 55 in the hole 101, as shown in FIG. 6.

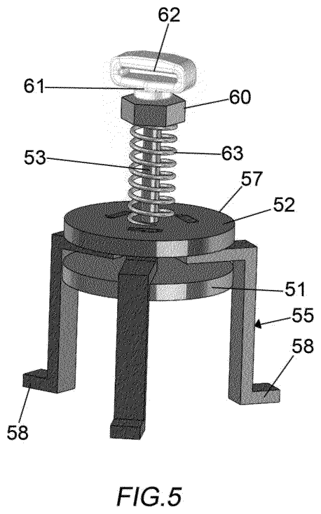

In this condition, by rotating the threaded rod 53 in the direction of screwing in the threaded hole 54 of the upper disk 52, since this disk is prevented from rotating, a backward movement of the lower disk 51 is produced, and therefore its moving closer to the upper disk 52, with consequent expansion of the tabs 55, as shown in FIG. 5, which go to engage with the inner surface 103 of the hole 101 producing the locking of device 50 in the hole 101 following tight tightening.

A possible unhooking of device 50 from hole 101 is prevented, as well as by the strong engagement of the bent ends 58 of the tabs 55 with the inner surface 103 of hole 101, by an inner perimeter protrusion 104, normally provided for the hooking of the cover disk (removed), against which the bent ends 58 of the tabs 55 would abut. In FIGS. 4 and 6 the bent ends 58 of tabs 55 are shown at a certain distance from the perimeter protrusion 104, but in practice they are closer to protrusion 104, or in any case they can be made in such a way as to be closer to protrusion 104 or even to abut against it.

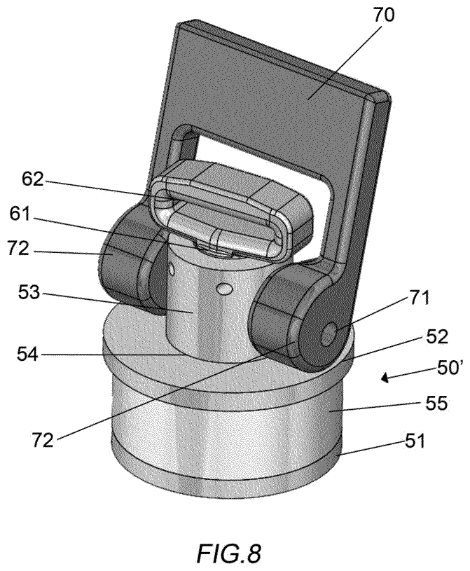

The spring 63 can contribute to avoiding any unscrewing of the rod 53 after mounting. Referring to FIGS. 8 to 11, a description is now given of a second embodiment of the fixing device, denoted by reference numeral 50′, using the same reference numerals of the previous embodiment to distinguish identical or similar parts.

The device 50′ again comprises two parallel and coaxial disks 51, 52, with a rod 53 attached to the lower disk 51 and traversing a smooth hole 54 provided centrally to the upper disk 52.

Around the rod 53, which in this case is shown to have a larger diameter with respect to the rod 53 of the previous embodiment, a toroidal expandable elastic element 55 is arranged.

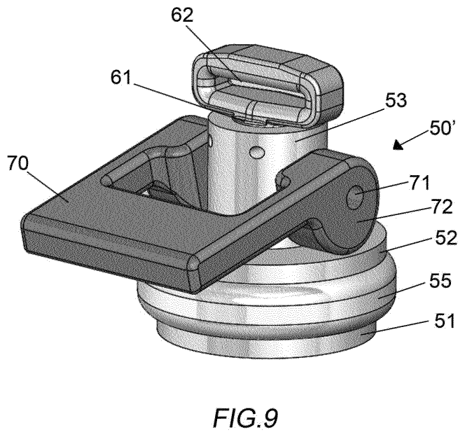

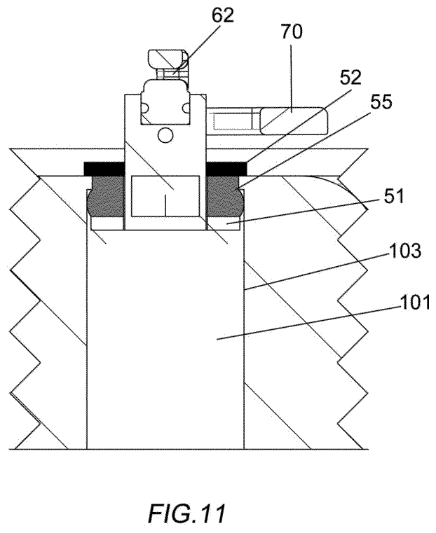

At the section of the rod 53 protruding beyond the upper disk 52 a lever 70 is hinged, having, at the hinge axis 71, a pair of cam profiles 72 in contact with the upper disk 52. The cam profiles 72 are such that rotating lever 70 from the position shown in FIGS. 8 and 10 to the position shown in FIGS. 9 and 11 causes the lower disk 51 to move closer to the upper disk 52 and therefore the expansion of the elastic element 55, which goes to abut against the inner wall 103 of the hole 101, producing the locking of the fixing device 50′ in the hole 101.

In this embodiment, at the top of the rod 53 a small pin 61 is shown again with eyelet 62 for the attachment of the belt 10, or generic connecting element, to the central body 2 of the anti-skid device 1.

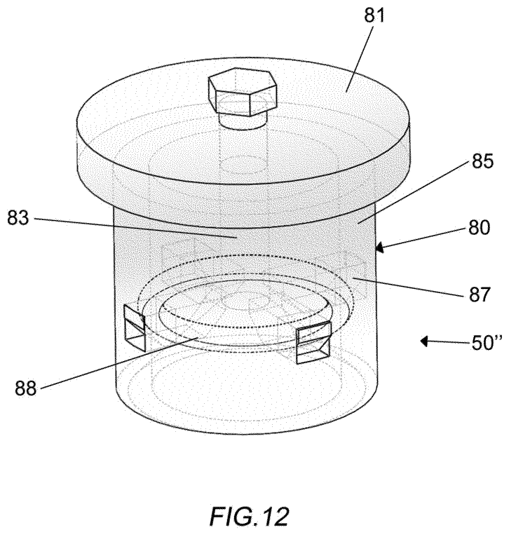

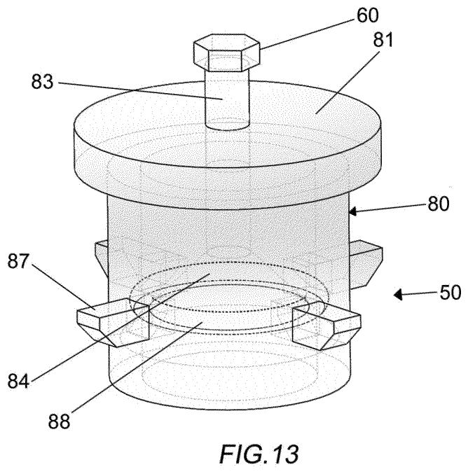

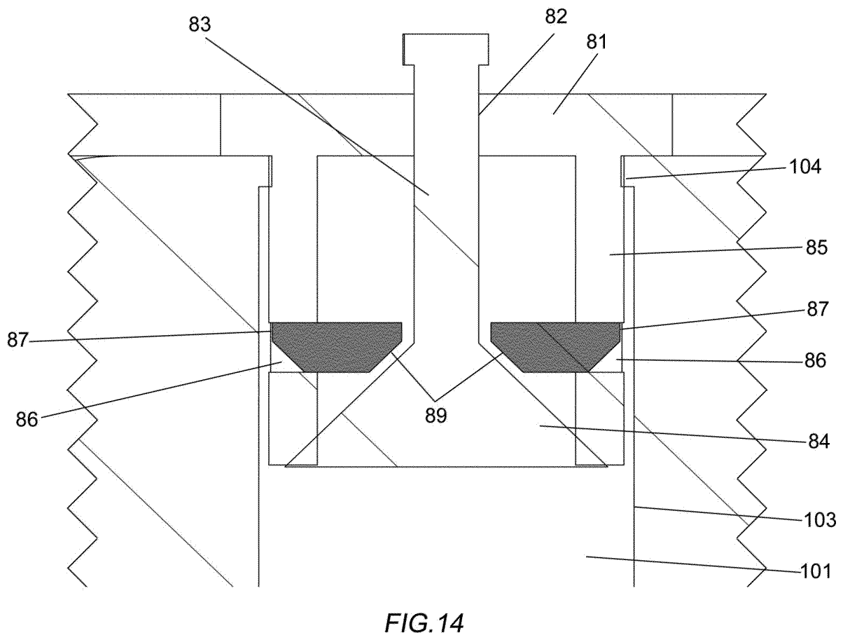

FIGS. 12 to 15 show a third embodiment of the fixing device denoted by reference numeral 50″.

This device comprises a hollow cylinder 80, open below and having a widened upper base 81, having a central threaded hole 82 in which a rod 83, at least partially threaded, carrying a conical body 84 below, is engaged.

In the side wall 85 of the hollow cylinder 80 holes 86 are provided (four in number in the accompanying drawings, arranged at 90° one in relation to the other), in which blocks 87 are housed, held together by a toroidal rubber ring 88, which traverses them. The blocks 87 have an internal bevel 89 with an inclination corresponding to that of the conical body 84.

In the accompanying drawings a similar bevel is also provided on the outer side of blocks 87, in such a way that they are perfectly symmetrical, and their mounting can be simplified.

At the upper end of the rod 83 a polygonal head 60 is provided with small pin 61 and eyelet 62 (not shown in the drawings), as in previous embodiments.

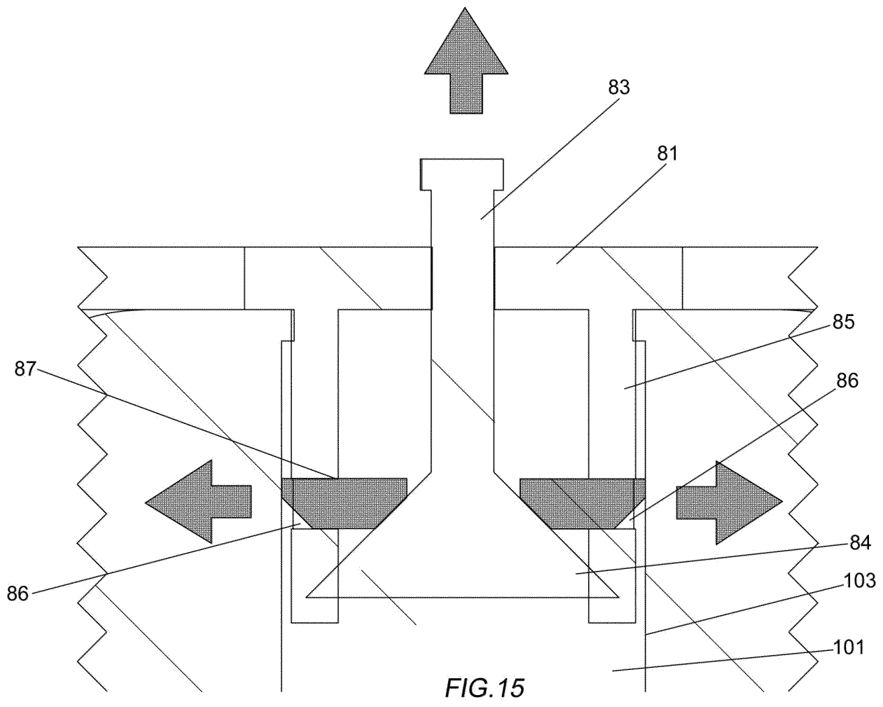

A rotation of the threaded rod 83, in engagement with the threaded hole 82 of the base 81 of the hollow cylinder 85, produces a lifting of the conical body 84, which slides against the inclined surfaces 89 of the blocks 87, producing the release thereof from the cylinder and the engagement against the inner surface 103 of the hole 101 (FIG. 15) determining the locking of the fixing device 50″.

From what has been disclosed above, the advantages of the snow chain according to the invention are clear, whose device for fixing to the wheel can be easily mounted in the central hole of an alloy rim, ensuring uniform tensioning of the chain.

Naturally the invention is not limited to the particular embodiments previously described and illustrated in the accompanying drawings, but numerous detailed changes can be made thereto by the person skilled in the art, without thereby departing from the scope of the invention itself, as defined in the appended claims.

1. Anti-skid device with mounting from the outside for wheels, comprising:
a central body intended to be placed at the hub of a wheel on which the anti-skid device is to be mounted,
a plurality of arms protruding radially from said central body and ending in terminal elements intended to be placed on the tire tread,
chain segments connected to said terminal elements so as to form a ring on the tire tread,
a device suitable for being fixed to said rim of the wheel;
a connection element between said device and said central body of the anti-skid device, and
a tensioning mechanism arranged in said central body that can be actuated to pull said connecting element and bring the central body closer to the wheel hub, wherein said device is an expansion device which is fixed in said central hole of the rim of the wheel.

2. The anti-skid device according to claim 1, wherein said expansion fixing device comprises a pair of parallel and coaxial disks,
at least one expandable element placed between them, a rod having one end connected to a first of said disks and traversing a central hole in a second of said disks, means of manual actuation of said rod to cause the approach between said disks and therefore the expansion of said expandable element.

3. The anti-skid device according to claim 2, wherein said expansion fixing device comprises a plurality of expandable elements in the form of L-shaped tabs with ends bent outwards, the first ends housed in corresponding holes in said second disk, and the second ends engaging with the inner wall of said hole in condition of use of the device, said rod being at least partially threaded and engaging with said hole, also threaded, provided in said second disk to cause the approaching or distancing between said disks and therefore the expansion or the retraction of said tabs.

4. The anti-skid device according to claim 3, wherein said rod has a head and a spring is arranged around the rod, acting between said head and said second disk.

5. The anti-skid device according to claim 2, wherein said expansion fixing device comprises an elastically expandable toroidal element arranged around said rod between said two disks, a pivoting lever having cam profiles at the hinge axis, in contact with second disk, being hinged to the section of said rod projecting externally from said second disk, such that a rotation of the lever causes said disks to come closer together and therefore the expansion of said toroidal elastic element.

6. The anti-skid device according to claim 1, wherein said expansion fixing device comprises a hollow cylinder, open on one side and having a widened base able to abut against the rim of the wheel in use condition, centrally to said base a threaded hole being provided, with which a rod, at least partially threaded, engages, having an end projecting externally from said base and carrying at the other end a conical body housed in said hollow cylinder, in the side wall of the cylinder, through holes being provided, housing respective blocks having internally a bevel with the same inclination of said conical body, so that a displacement of said conical body towards said blocks caused by the screwing of said rod produces the radial expansion of said blocks- and their engagement with the inner wall of said hole.

7. The anti-skid device according to claim 6, wherein said blocks are joined one to the other by an elastic toroidal element which traverses them.

8. The anti-skid device according to claim 1, wherein said element connecting the fixing device and the central body of the anti-skid device, is a belt, a chain, a metal cable or the like.

9. The anti-skid device according to claim 1, wherein a small pin with an eyelet is provided at the free end of said rod for engagement of said connecting element.

10. The anti-skid device according to claim 1, wherein said central hole of the rim has frontally a perimetral edge projecting inwards.

11. The anti-skid device according to claim 2, wherein said element connecting the fixing device and the central body of the anti-skid device, is a belt, a chain, a metal cable or the like.

12. The anti-skid device according to claim 3, wherein said element connecting the fixing device and the central body of the anti-skid device, is a belt, a chain, a metal cable or the like.

13. The anti-skid device according to claim 4, wherein said element connecting the fixing device and the central body of the anti-skid device, is a belt, a chain, a metal cable or the like.

14. The anti-skid device according to claim 5, wherein said element connecting the fixing device and the central body of the anti-skid device, is a belt, a chain, a metal cable or the like.

15. The anti-skid device according to claim 6, wherein said element connecting the fixing device and the central body of the anti-skid device, is a belt, a chain, a metal cable or the like.

16. The anti-skid device according to claim 7, wherein said element connecting the fixing device and the central body of the anti-skid device, is a belt, a chain, a metal cable or the like.

17. The anti-skid device according to claim 2, wherein a small pin with an eyelet is provided at the free end of said rod for engagement of said connecting element.

18. The anti-skid device according to claim 3, wherein a small pin with an eyelet is provided at the free end of said rod for engagement of said connecting element.

19. The anti-skid device according to claim 4, wherein a small pin with an eyelet is provided at the free end of said rod for engagement of said connecting element.

20. The anti-skid device according to claim 5, wherein a small pin with an eyelet is provided at the free end of said rod for engagement of said connecting element.
